(19) United States
(12) Patent Application Publication
(10) Pub. No.: US 2024/0230011 A9
(43) Pub. Date: Jul. 11, 2024

(54) PIPE COUPLING ENCAPSULATION ASSEMBLY

(71) Applicant: Krausz Industries Ltd., Rosh HaAyin (IL)

(72) Inventor: Avi Chiproot, Kfar-Saba (IL)

(73) Assignee: Krausz Industries Ltd., Rosh HaAyin (IL)

(21) Appl. No.: 18/048,902

(22) Filed: Oct. 24, 2022

(51) Int. Cl. F16L 55/172

(52) U.S. Cl. CPC F16L 55/1725

(57) ABSTRACT

A pipe coupling encapsulation assembly includes an elastomeric ring including two elastomeric annular pipe interface portions that extend from two opposite axial ends of an elastomeric intermediate annular portion. The elastomeric annular pipe interface portions have a smaller annular radius than an annular radius of the elastomeric intermediate annular portion. Each of the elastomeric annular pipe interface portions and the elastomeric intermediate annular portion includes edges that face each other when the elastomeric ring is placed around a pipe. A repair coupling includes a band and opposing clamp members extending outwards from ends of the band, the elastomeric ring being radially inwards of the band.

### FIELD OF THE INVENTION

The present invention relates generally to pipe coupling assemblies, such as those used to sealingly connect pipes together or to repair breaks or leaks in pipes, and particularly to methods for pipe coupling encapsulation in which the pipe coupling fits over existing pipes, bell-shaped joints, sleeve joints, and the like, and seals the pipes or joints.

### BACKGROUND OF THE INVENTION

Many kinds of removable band-type couplings for pipes exist in the art. It is noted that throughout the specification and claims, the term “pipe” encompasses any kind of generally cylindrical object, and the terms “clamp” and “coupling” are used interchangeably.

Many seals are not capable of being used externally over an existing coupling or existing bell joint, because they lack the internal space needed if the repair seal is to be applied over and around an existing but leaking pipe joint. A solution known in the art is a split seal encapsulation pipe repair assembly. The encapsulation seal assembly fits over existing pipes, bell-shaped joints, sleeve joints and the like, and seals the joint. The encapsulation seal assembly includes two metal half-rings that are bolted together at top and bottom flanges of the half-rings. Two elastomeric sealing half-rings are permanently attached to the inside of the two metal half-rings, and these sealing half-rings are clamped on both sides of the leak to stop the leak.

### SUMMARY OF THE INVENTION

The present invention seeks to provide an improved method for pipe coupling encapsulation, as is described more in detail further below. In the prior art, the seals of the encapsulation assembly are only placed at the ends of the assembly; there is no elastomer over the axial length of the assembly. In contrast, in the present invention, the elastomeric seal extends over the entire axial length of the assembly. The axial edges of the elastomeric seal abut against each other when the assembly is clamped to the pipes. A keeper element may be provided to ensure that the edges abut against each other and do not overlap each other.

There is provided in accordance with a non-limiting embodiment of the present invention a pipe coupling encapsulation assembly including an elastomeric ring including two elastomeric annular pipe interface portions that extend from two opposite axial ends of an elastomeric intermediate annular portion, the elastomeric annular pipe interface portions having a smaller annular radius than an annular radius of the elastomeric intermediate annular portion, each of the elastomeric annular pipe interface portions and the elastomeric intermediate annular portion including edges that face each other when the elastomeric ring is placed around a pipe, and a repair coupling which includes a band and opposing clamp members extending outwards from ends of the band, the elastomeric ring being radially inwards of the band.

In accordance with a non-limiting embodiment of the present invention a keeper element couples an inner surface of the elastomeric intermediate annular portion to the band.

In accordance with a non-limiting embodiment of the present invention the keeper element includes a first portion that circumferentially extends over the edges of the elastomeric intermediate annular portion and a second portion extending radially inwards from the first portion.

In accordance with a non-limiting embodiment of the present invention the second portion is axially inwards of inner axial surfaces of the elastomeric annular pipe interface portions.

In accordance with a non-limiting embodiment of the present invention, when the opposing clamp members are tightened, the edges of the elastomeric intermediate annular portion and of the elastomeric annular pipe interface portions abut against each other.

There is provided in accordance with a non-limiting embodiment of the present invention a method for pipe coupling encapsulation including placing an elastomeric ring around a pipe element (which could be a flange, pipe or pipes, or bell joint or other items), the elastomeric ring including two elastomeric annular pipe interface portions that extend from two opposite axial ends of an elastomeric intermediate annular portion, the elastomeric annular pipe interface portions having a smaller annular radius than an annular radius of the elastomeric intermediate annular portion, each of the elastomeric annular pipe interface portions and the elastomeric intermediate annular portion including edges that face each other when the elastomeric ring is placed around the pipe, and the elastomeric ring being radially inside a repair coupling which includes a band and opposing clamp members extending outwards from ends of the band, and tightening the opposing clamp members towards each other with one or more tightening elements, wherein when the opposing clamp members are tightened, the edges of the elastomeric intermediate annular portion and of the elastomeric annular pipe interface portions abut against each other.

In accordance with a non-limiting embodiment of the present invention a keeper element couples an inner surface of the elastomeric intermediate annular portion to the band, and the keeper element is used to maintain the edges of the elastomeric intermediate annular portion and of the elastomeric annular pipe interface portions in abutment against each other.

### BRIEF DESCRIPTION OF THE DRAWINGS

The present invention will be understood and appreciated more fully from the following detailed description, taken in conjunction with the drawings in which:

FIGS. 1 and 2 are perspective illustrations of a pipe coupling encapsulation assembly, in accordance with a non-limiting embodiment of the present invention.

### DETAILED DESCRIPTION

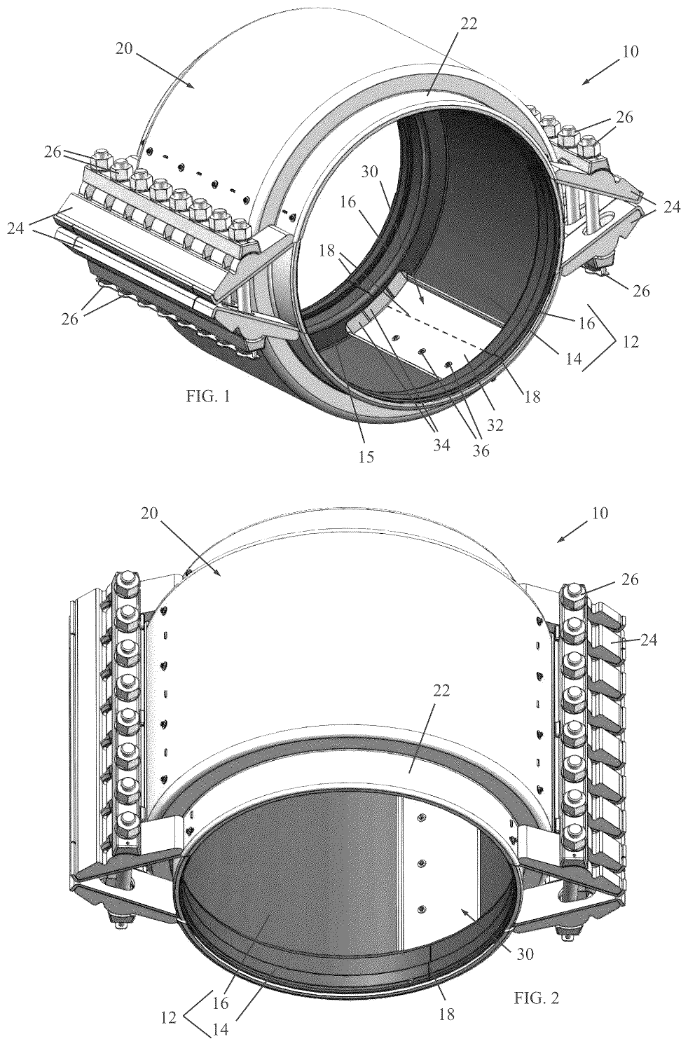

Reference is now made to FIGS. 1 and 2, which illustrate a pipe coupling encapsulation assembly 10, in accordance with a non-limiting embodiment of the present invention.

The pipe coupling encapsulation assembly 10 may include an elastomeric ring 12 that includes two elastomeric annular pipe interface portions 14 that extend from two opposite axial ends of an elastomeric intermediate annular portion 16. The elastomeric annular pipe interface portions 14 each have a smaller annular radius than an annular radius of the elastomeric intermediate annular portion 16. In this manner, the elastomeric annular pipe interface portions 14 can seal against the outer contour of a pipe or pipes, and the elastomeric intermediate annular portion 16 can accommodate a larger diameter of a bell-shaped joint or other structure at the site of the pipe repair.

The elastomeric annular pipe interface portions 14 can have the same annular radius. Alternatively, the elastomeric annular pipe interface portions 14 can each have a different annular radius to accommodate different size pipes.

Each of the elastomeric annular pipe interface portions 14 and the elastomeric intermediate annular portion 16 includes edges 18 that face each other when the elastomeric ring 12 is placed around a pipe. (The edges 18 of the elastomeric intermediate annular portion 16 are shown in hidden, broken lines in FIG. 1.)

The pipe coupling encapsulation assembly 10 may include a repair coupling 20 which includes a band 22 (typically made of metal) and opposing clamp members 24 extending outwards from ends of band 22. The elastomeric ring 12 is radially inwards of band 22. Fasteners 26 are used to tighten the clamp members 24 towards each other. It is seen that band 22 preferably has a shape complimentary to elastomeric ring 12, so that it has an intermediate portion with a larger radius than end portions that correspond to the elastomeric annular pipe interface portions 14.

In accordance with a non-limiting embodiment of the present invention a keeper element 30 is coupled to an inner surface of elastomeric intermediate annular portion 16 and to band 22, such as with one or more fasteners 36 (e.g., rivets or screws). In the non-limiting illustrated embodiment, keeper element 30 includes a first portion 32 that circumferentially extends over edges 18 of elastomeric intermediate annular portion 16, and a second portion 34 extending radially inwards from first portion 32. The second portion 34 is axially inwards of inner axial surfaces 15 of elastomeric annular pipe interface portions 14.

When the opposing clamp members 24 are tightened, the edges 18 of elastomeric intermediate annular portion 16 and of the elastomeric annular pipe interface portions 14 abut against each other.

Accordingly, the pipe coupling encapsulation assembly 10 may be used to repair pipes or leaking pipe joints, without having to interrupt flow through the pipes and joint couplings.

In use, a worker places the elastomeric ring 12 around the pipes on opposite sides of the pipe element. (In the illustrated embodiment, there is one elastomeric ring 12, but more than one can be used, too, each one being a partial ring.) The worker takes repair coupling 20 and places band 22 around the pipe element such that opposite end portions of band 22 overlie elastomeric ring 12. The worker than tightens opposing clamp members 24 towards each other with tightening elements 26 and the repair is complete.

Keeper element 30 can maintain edges 18 of elastomeric intermediate annular portion 16 and of elastomeric annular pipe interface portions 14 in abutment against each other, even under vacuum conditions.

What is claimed is:

1. A pipe coupling encapsulation assembly comprising:
an elastomeric ring comprising two elastomeric annular pipe interface portions that extend from two opposite axial ends of an elastomeric intermediate annular portion, said elastomeric annular pipe interface portions having a smaller annular radius than an annular radius of said elastomeric intermediate annular portion, each of said elastomeric annular pipe interface portions and said elastomeric intermediate annular portion comprising edges that face each other when said elastomeric ring is placed around a pipe; and
a repair coupling which comprises a band and opposing clamp members extending outwards from ends of said band, said elastomeric ring being radially inwards of said band.

2. The pipe coupling encapsulation assembly according to claim 1, wherein a keeper element couples an inner surface of said elastomeric intermediate annular portion to said band.

3. The pipe coupling encapsulation assembly according to claim 2, wherein said keeper element comprises a first portion that circumferentially extends over said edges of said elastomeric intermediate annular portion and a second portion extending radially inwards from said first portion.

4. The pipe coupling encapsulation assembly according to claim 3, wherein said second portion is axially inwards of inner axial surfaces of said elastomeric annular pipe interface portions.

5. The pipe coupling encapsulation assembly according to claim 1, wherein when said opposing clamp members are tightened, said edges of said elastomeric intermediate annular portion and of said elastomeric annular pipe interface portions abut against each other.

6. A method for pipe coupling encapsulation comprising:
placing an elastomeric ring around a pipe element, said elastomeric ring comprising two elastomeric annular pipe interface portions that extend from two opposite axial ends of an elastomeric intermediate annular portion, said elastomeric annular pipe interface portions having a smaller annular radius than an annular radius of said elastomeric intermediate annular portion, each of said elastomeric annular pipe interface portions and said elastomeric intermediate annular portion comprising edges that face each other when said elastomeric ring is placed around the pipe; and
said elastomeric ring being radially inside a repair coupling which comprises a band and opposing clamp members extending outwards from ends of said band; and
tightening said opposing clamp members towards each other with one or more tightening elements, wherein when said opposing clamp members are tightened, said edges of said elastomeric intermediate annular portion and of said elastomeric annular pipe interface portions abut against each other.

7. The method according to claim 6, wherein a keeper element couples an inner surface of said elastomeric intermediate annular portion to said band, and using said keeper element to maintain said edges of said elastomeric intermediate annular portion and of said elastomeric annular pipe interface portions in abutment against each other.
